(19) United States
(12) Patent Application Publication
(10) Pub. No.: US 2008/0297110 A1
(43) Pub. Date: Dec. 4, 2008

(54) METHOD AND SYSTEM FOR CONTROLLING THE DISTRIBUTION OF POWER IN A MULTI-BATTERY CHARGER

(76) Inventor: Kevin CORDES, Miller Place, NY (US)

Correspondence Address: FAY KAPLUN & MARCIN, LLP, 150 BROADWAY, SUITE 702, NEW YORK, NY, 10038, US

(21) Appl. No.: 11/756,264

(22) Filed: May 31, 2007

(51) Int. Cl. H02J 7/00

(52) U.S. Cl. 320/110; 320/107; 320/126

(57) ABSTRACT

Described are a method and a system for controlling the distribution of power in a multi-battery charger. The system includes (a) a housing including a plurality of contacts configured to electrically couple with a plurality of batteries; and (b) a controller. The controller is programmed to: detect a connection status for each of the contacts by determining which of the plurality of contacts is coupled to a battery, determine a charge status of each coupled battery, and determine for each contact a respective charging current having a respective magnitude.

### FIELD OF THE INVENTION

The present invention relates to a method and system for controlling the distribution of power in a multi-battery charger.

### BACKGROUND INFORMATION

A multi-battery charger can recharge more than one battery at the same time. Such a charger includes a plurality of slots to which are coupled a corresponding number of batteries. Each slot is shaped to receive one battery and includes at least one electrical contact for delivering power from an external power supply. When a battery is fully charged or decoupled from the charger, a charging current is still supplied to the now-empty slot because such prior chargers have no ability to divert the unused charging current to the slots still holding batteries requiring recharging. This inability to adjust the distribution of charging currents when a battery is fully charged or disconnected thus results in the charger having some of its charging capabilities sit idle, and requires the use of more expensive power supplies to compensate for such inefficient use. What is needed is a multi-battery charger that can dynamically control the distribution of power from a power supply based on the number of batteries currently connected to the charger and on the charge status of such connected batteries.

### SUMMARY OF THE INVENTION

The present invention relates to a method and a system for controlling the distribution of power in a multi-battery charger. The system includes (a) a housing including a plurality of contacts configured to electrically couple with a plurality of batteries; and (b) a controller. The controller is programmed to: detect a connection status for each of the contacts by determining which of the plurality of contacts is coupled to a battery, determine a charge status of each coupled battery, and determine for each contact a respective charging current having a respective magnitude.

The method includes the following steps. A connection status of each of a plurality of electrical contacts of a charger which is configured to be electrically coupled to a battery is determined. The connection status is positive when the associated electrical contact is coupled to the battery, and the connection status is negative when the associated electrical contact is not coupled to the battery. A charging current is divided only over those electrical contacts having a positive connection status.

### BRIEF DESCRIPTION OF THE DRAWINGS

FIG. 1 shows a multi-battery charger according to an exemplary embodiment of the present invention.

FIG. 2 shows the multi-battery charger of claim 1 loaded with a different amount of batteries than in FIG. 1.

FIG. 3 shows a graph of the charging current and battery voltage for batteries coupled to the charger of FIG. 1.

FIG. 4 shows a second graph of the charging current and battery voltage for batteries coupled to the charger of FIG. 1.

FIG. 5 shows a flow diagram illustrating an operation of the charger of FIG. 1.

FIG. 6 shows a flow diagram illustrating a further operation of the charger of FIG. 1.

### DETAILED DESCRIPTION

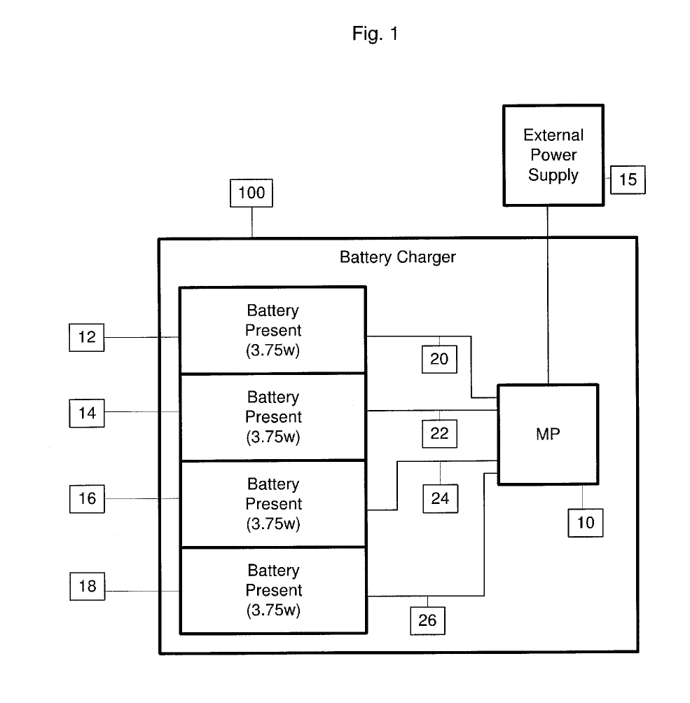

FIG. 1 shows the multi-battery charger 100 according to an exemplary embodiment of the present invention. The charger 100 includes a plurality of battery slots 12, 14, 16, 18, each of which includes at least one electrical contact for mating with, or otherwise connecting to, a corresponding contact on a battery to be recharged. The slots may be formed as receptacles shaped and sized to conform to the dimensions of a battery; alternatively, the battery charger may omit such slots and merely include as many sets of electrical contacts as the number of batteries it is intended to recharge. Moreover, although FIG. 1 shows the slots 12, 14, 16, 18 in a side-by-side configuration, the battery charger 100 is compatible with other configurations, such as one in which the batteries are stacked on top of each other inside a compartment of charger 100, or one in which the batteries are connected to the power supply contacts of the charger 100 in such a way that they are left standing vertically as they recharge. Moreover, although the battery slots 12, 14, 16, 18 are illustrated as being the same in size and shape, the present invention covers as well multi-battery chargers provided with slots that differ from each other in size or shape in order to accommodate differently shaped or sized batteries, and also covers chargers with electrical battery contacts that differ from each other in order to accommodate batteries of different types. For example, one set of contacts in charger 100 may be suitable for a 9V battery, while still another set of contacts in the same charger may be suitable for size D batteries. In this way, the battery charger 100 is well-suited to charging multiple types of batteries that differ in shape from each other.

Battery charger 100 includes a controller 10 that can include a microprocessor, ASIC, and specific charging circuitry to regulate the charging of a battery (“charge regulation circuitry”). Accordingly, the microprocessor may control the charge regulation circuitry, while the charge regulation circuitry may handle the power management for charging. A plurality of signal lines 20, 22, 24, and 26 connects to controller a respective one of the battery slots 12, 14, 16, and 18. Controller 10 is also connected to an external power supply 15. Power supply 15, controller 10, and slots 12, 14, 16, and 18 can also be included within a common housing. Controller 10 can control the distribution of charge currents to the battery slots 12, 14, 16, and 18 via respective signal lines 20, 22, 24, 26. In order to control the charge current distribution, controller detects (through separate signal lines that are not shown) whether or not each slot is coupled to a battery for recharging, and also detects the charge status of each coupled battery (i.e., the amount of charge stored in the battery), either in absolute terms, or as a percentage of the maximum charge storage capacity for the battery. For instance, in FIG. 1, every battery slot is occupied with a battery requiring recharging. In this example illustrated in FIG. 1, the power supply is capable of delivering 15 Watts, and each slot 12, 14, 16, and 18 receives 3.75 Watts. The microprocessor of the controller 10 senses this, and so distributes evenly the power from external supply 15 over lines 20, 22, 24, and 26. Specifically, the microprocessor may measure a voltage for each of slots 12, 14, 16, and 18. A voltage measure at one of the slots within a certain voltage range will indicate the presence of a battery at that particular slot. Alternatively, the microprocessor may communicate with a microchip residing on or within a battery in order to detect the presence of the battery.

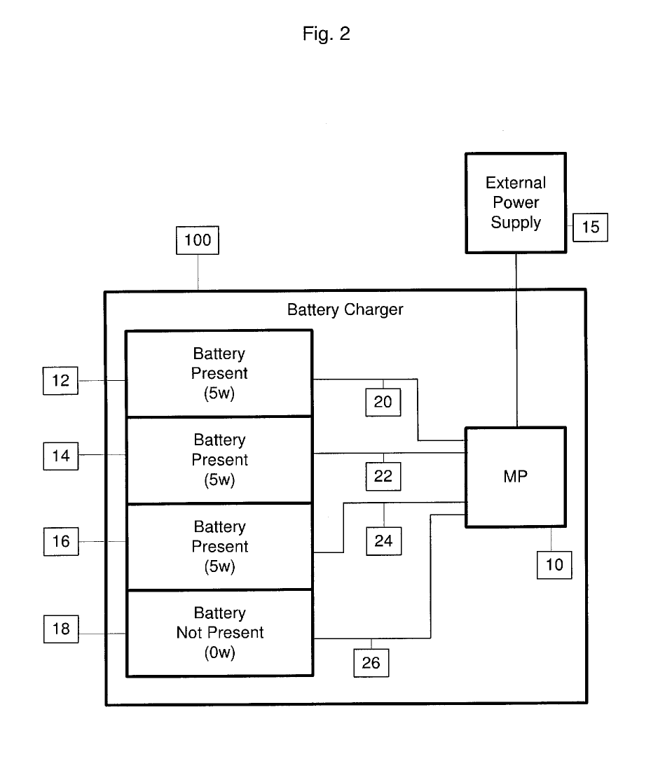

FIG. 2 shows the same battery charger 100, but only slots 12, 14, 16 are loaded with batteries for recharging. Since the controller 10 detects that no battery is inserted in slot 18, it redistributes the 15 Watts from external power supply 15 by supplying 5 Watts to each one of slots 12, 14, and 16. Thus, through the ability to detect which slots are loaded with batteries, the controller 10 can dynamically adjust the amount of power that each slot receives. Had only a single slot been occupied, then controller 10 would have supplied it with the full 15 Watts of power from the external power supply 15. Thus, rather than not utilizing the excess power that sits idle, the battery charger 100 re-routes this excess power to those slots loaded with batteries for recharging. Therefore, the power supply will be fully utilized, allowing for improved efficiency of the power supply. As a result, a less expensive external power supply can be used, and the batteries can be charged to full capacity more quickly.

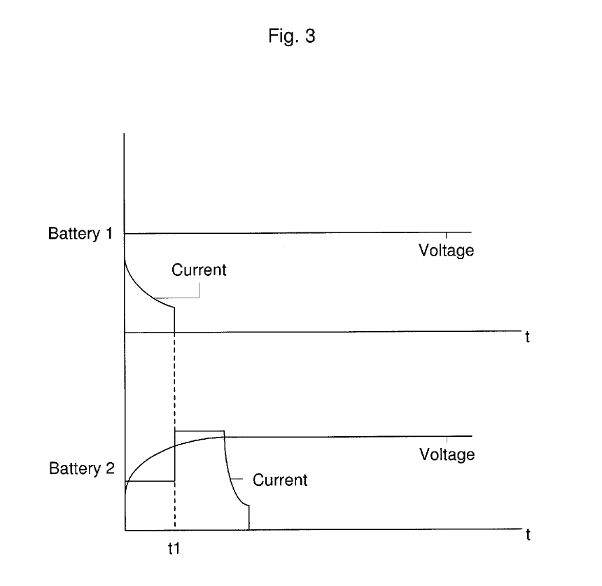

The controller 10 can adjust the distribution of charging currents to the slots 12, 14, 16, and 18 based on factors other than the mere presence or absence of a battery in a particular slot. For instance, the controller 10 can detect the charge state of a battery during charging. Specifically, the microprocessor may continuously measure the current going into each of the batteries of the slots 12, 14, 16, and 18. For example, these measurements may be taken through the use of a current sense resistor and a differential amplifier. As a battery nears a full charge, its power needs correspondingly ramp down. Based on how nearly fully charged a battery is, the controller can determine the extent of the ramp-down in charging current for this battery, and distribute the charging current that this battery had been receiving to other batteries with larger power needs. This ability to adjust a charging current based on the current charge status of a battery is shown in FIG. 3, which shows the charging state vs. time of two batteries inserted into battery charger 100. The top graph illustrates battery 1 having been charged to its maximum value; when controller 10 detects the complete charging of battery 1, it ramps down the charging current to the slot of battery 1 at time t and correspondingly ramps up the charging current for battery 2. In other words, the charging current that had been supplied to battery 1 is re-routed by controller 10, upon the complete charging of battery 1, to battery 2. Thus, the battery charger 100 of the present invention can program the charge currents supplied to the batteries based on their charge states. If, in addition to battery 2 of the example of FIG. 3, other batteries inserted into charger 100 had also required further charging at the time when battery 1 finished charging, the controller 10 would have ramped up the charge currents to those batteries as well. In such a situation, the controller 10 can divide evenly the supply current being re-routed from battery 1, so that, for example, if the supply current to battery 1 had been 6 Amps, and the number of remaining batteries requiring recharging is 3, each remaining battery requiring recharging would receive 2 Amps. Alternatively, the surplus current resulting from the cessation of charging current delivery to battery 1 may be divided by controller according to the individual charging needs of the remaining batteries, such needs being determined by the current charge status of the batteries. For instance, battery 2 may require a charging current of 2 Amps, battery 3 may require 1 Amp, and battery 4 may require 3 Amps.

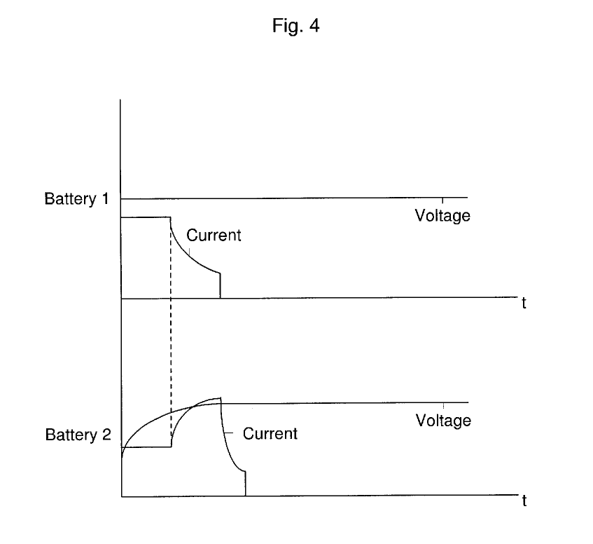

Under an alternative charging scheme shown in FIG. 4, the programmed charge current can be modified for a battery that is in the constant current (CC) charging mode when another battery is in the constant voltage (CV) charging mode. Specifically, as shown in FIG. 4, as the current of battery 1 in the CV mode drops, the resulting surplus power can be dynamically applied to battery 2 in the CC mode. This re-routing is done by controller 10. Under the charging scheme of FIG. 4, the controller need not wait until the charging of battery 1 is completed—the ramp up in the charging current of battery 2 can begin as soon as the charging current to battery 1 begins to drop, as seen in the rising curved region for the charging current of battery 2.

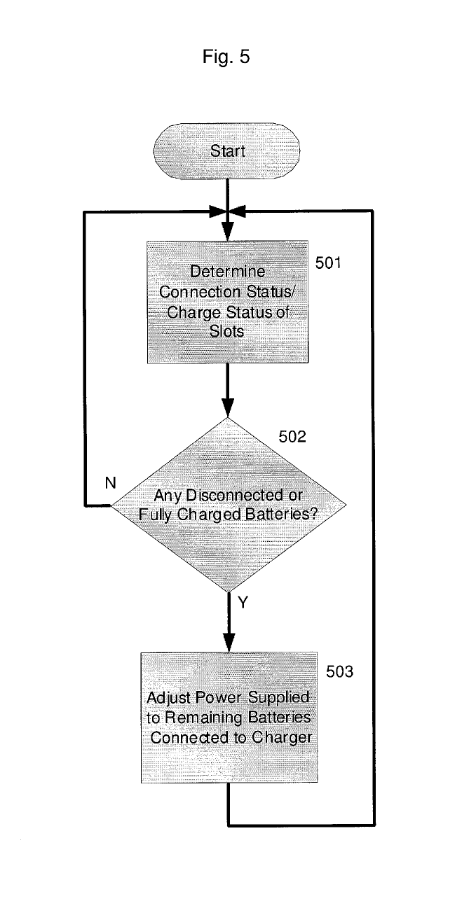

FIG. 5 shows a flow diagram corresponding to an operation of the present invention. The controller 10 begins the operation by determining the connection status of all the battery slots of the charger 100 (i.e., which slots have batteries connected thereto), as well as the amount of charge in each connected battery. (Step 501). If the controller 10 determines that none of the batteries are either disconnected or fully charged at each of the slots (Step 502), the controller 10 may return to Step 501 to continue monitoring connect status and charge status for each of the slots of the charger 100. However, if the controller 10 determines that at least one slot is empty, for example, when a current is no longer supplied to a particular slot as a result of a battery being decoupled from the charger 100, or that at least one battery connected to the charger 100 is fully charged (step 502), the controller 10 diverts power from the empty slots and the slots containing fully charged batteries to those slots containing batteries that require further charging. (Step 503). The diverted surplus power may be divided equally over the slots containing batteries requiring further charging, or the surplus power may be divided in proportion to the charge status of each connected battery. Under the latter charging mode, the closer a battery is to a full charge, the less of the diverted power is supplied to it. Thus, based on this dynamic control of power distribution, a savings in charge cycle time can be achieved. Specifically, this approach will provide significant time savings when the battery charge cycles are out of sync with each other (that is, when the batteries are connected to or removed from the charger at different times), or when less than all the available battery slots are used. As illustrated in FIG. 5, once the power supplied to remaining batteries connected to the charger has been adjusted, the controller 10 may return to Step 501 to continue monitoring connect status and charge status for each of the slots of the charger 100.

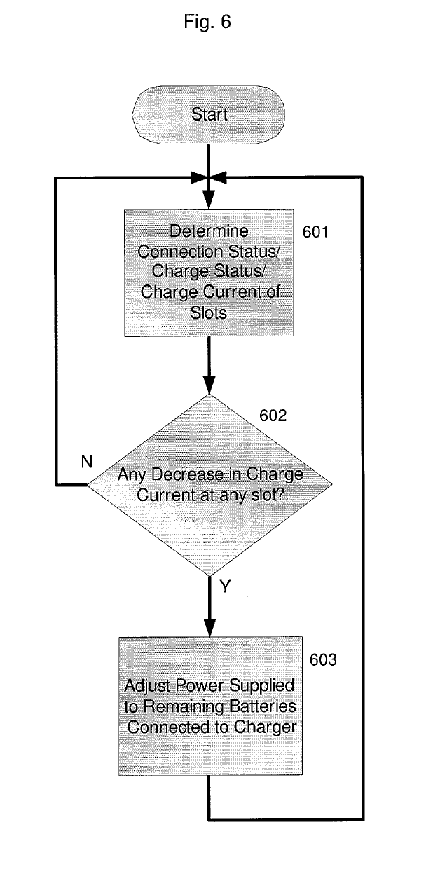

FIG. 6 shows a flow diagram corresponding to an alternative operation of the present invention. In addition to the power distribution described in FIG. 5 that may result from a battery being removed or being fully charged, an alternative power distribution method may be performed when a battery in need of charging is inserted into an empty slot. Similar to the system illustrated in FIG. 5, the controller 10 begins the operation by determining the connection status of all the battery slots of the charger 100 (i.e., which slots have batteries connected thereto), as well as the amount of charge in each connected battery. (Step 601). In addition, the controller 10 may also determine a charge current for each of the battery slots of the charger 100. If the controller 10 does not detect a decrease in the charge current at any of the slots (Step 602), the controller 10 may return to Step 601. However, if the controller 10 then determines that there is a decrease in charge current is detected in at least one slot (step 602), the controller 10 diverts power from the slots experiencing a decrease in charge current to those slots containing batteries that require further charging. (Step 603). Thus, the other batteries that are in the process of charging may have the current decreased for their respective slots in order to provide power to charge the newly inserted battery. Finally, when the power supplied to remaining batteries connected to the charger has been adjusted, the controller 10 may then return to Step 601 to continue monitoring connect status and charge status for each of the slots of the charger 100.

According to further alternative embodiments of the present invention, this distribution power may also be applied to a charger that can charge different batteries having different battery capacities. When the microcontroller determines that a battery is present in a particular slot, the microprocessor can determine the battery capacity for that battery. For example, the microprocessor may read an Electrically Erasable Programmable Read-Only Memory (“EEPROM”) resident within the battery in order to determine the battery capacity. Once this is known, the microcontroller may distribute the appropriate amount of power to that battery. If a different battery having a different battery capacity is placed in the same slot, the microcontroller may distribute a different amount of power to this different battery.

What is claimed is:

1. A system, comprising:
a housing including a plurality of contacts configured to electrically couple with a plurality of batteries; and
a controller programmed to:
detect a connection status for each of the contacts by determining which of the plurality of contacts is coupled to a battery,
determine a charge status of each coupled battery, and
determine for each contact a respective charging current having a respective magnitude.

2. The system of claim 1, wherein the controller includes at least one of a microprocessor, ASIC, and a charge regulation circuitry.

3. The system of claim 1, wherein the housing includes a plurality of slots, at least one of shaped to match a contour of a surface of a battery, and wherein each contact is arranged in one of the plurality of slots.

4. The system of claim 1, wherein the housing includes a plurality of slots, a first one of the slots shaped to match a surface contour of a battery of a first type and a second one of the slots shaped to match a surface contour of a battery of a second type, and wherein each contact is arranged in one of the plurality of slots.

5. The system of claim 1, wherein if a battery is disconnected from the plurality of contacts, the controller re-routes a charging current previously supplied to the disconnected battery to at least one battery remaining connected to the housing.

6. The system of claim 1, wherein if a battery is disconnected from the plurality of contacts, the controller re-routes a charging current previously supplied to the disconnected battery to at least two batteries remaining connected to the housing, and wherein the re-routed charging current is divided substantially equally between the at least two remaining batteries.

7. The system of claim 1, wherein if a battery is disconnected from the plurality of contacts, the microprocessor re-routes a charging current previously supplied to the disconnected battery to at least two batteries remaining connected to the housing, and the re-routed charging current is divided between the at least two remaining batteries based on a charge status of at least one of the at least two remaining batteries.

8. A method, comprising:
determining a connection status of each of a plurality of electrical contacts of a charger which is configured to be electrically coupled to a battery, the connection status being positive when the associated electrical contact is coupled to the battery, and the connection status being negative when the associated electrical contact is not coupled to the battery; and
dividing a charging current only over those electrical contacts having a positive connection status.

9. The method of claim 8, further comprising:
supplying the charging current from an external power supply.

10. The method of claim 8, further comprising:
if the battery is decoupled from an electrical contact, diverting any charging current that had been supplied to the electrical contact when the battery was connected thereto to at least one of the electrical contacts to which another battery remains connected.

11. The method of claim 10, further comprising:
determining a charge status for each battery connected to the charger, wherein the diverting step includes diverting to each connected battery a respective portion of the charging current that had been previously supplied to the decoupled battery, the respective portion of the charging current being based on the charge status of the associated connected battery.

12. A method, comprising:
supplying to a plurality of batteries connected to a charger a respective plurality of charging currents; and
if one of the batteries becomes one of fully charged and disconnected from the charger, diverting the charging current of the battery that is one of fully charged and disconnected from the charger to at least one other battery connected to the charger.

13. The method of claim 12, wherein:
the diverting includes dividing the charging current previously supplied to the battery that is one of fully charged and disconnected from the charger in proportion to a charge status of each connected battery requiring recharging.

14. A system, comprising:
means for determining a connection status of each of a plurality of electrical contacts of a charger configured to be electrically coupled to a battery, the connection status being positive when the associated electrical contact is coupled to the battery, and the connection status being negative when the associated electrical contact is not coupled to the battery; and
means for dividing a charging current only over those electrical contacts having a positive connection status.

15. The system of claim 14, further comprising:
means for supplying the charging current from an external power supply.

16. The system of claim 14, further comprising:
means for, if the battery is decoupled from an electrical contact, diverting any charging current that had been supplied to the electrical contact when the battery was connected thereto to at least one of the electrical contacts to which another battery remains connected.

17. The method of claim 16, further comprising:
means for determining a charge status for each battery connected to the charger, wherein the means for diverting includes diverting to each connected battery a respective portion of the charging current that had been previously supplied to the decoupled battery, the respective portion of the charging current being based on the charge status of the associated connected battery.

18. A system, comprising:
means for supplying to a plurality of batteries connected to a charger a respective plurality of charging currents; and
means for, if one of the batteries becomes one of fully charged and disconnected from the charger, diverting the charging current of the battery that is one of fully charged and disconnected from the charger to at least one other battery connected to the charger.

19. The system of claim 18, wherein:
the means for diverting includes means for dividing the charging current previously supplied to the battery that is one of fully charged and disconnected from the charger in proportion to a charge status of each connected battery requiring recharging.
